(19) United States
(12) Patent Application Publication
(10) Pub. No.: US 2010/0235852 A1
(43) Pub. Date: Sep. 16, 2010

(54) SYSTEM AND METHOD FOR IDENTIFYING CONTENT OF INTEREST TO A USER

(75) Inventor: Mark Gilmore Mears, Zionsville, IN (US)

Correspondence Address: FLETCHER YODER P.C., 7915 FM 1960 RD. WEST, SUITE 330, HOUSTON, TX, 77070, US

(73) Assignee: SHENZHEN TCL NEW TECHNOLOGY LTD., Shekou, Shenzhen,Guangdong (CN)

(21) Appl. No.: 12/740,670

(22) PCT Filed: Feb. 25, 2008
(86) PCT No.: PCT/US08/54882

§ 371 Date: Apr. 29, 2010

(30) Foreign Application Priority Data
Dec. 4, 2007 (CN) 200710124806.1

(51) Int. Cl. H04H 60/33

(52) U.S. Cl. 725/9

(57) ABSTRACT

There is provided a system and method for identifying content of interest to a user. More specifically, in one exemplary embodiment, there is provided a method comprising transmitting information about a user selected program to a central processing facility and receiving compiled collective wisdom data comprising information about a plurality of user-selected programs from the central processing facility. The exemplary method further comprises displaying the compiled collective wisdom data to an individual member of a user community to assist the individual member of the user community in selecting content of interest.

### FIELD OF THE INVENTION

The present invention relates generally to data gathering of television program viewing tendencies to aid a television viewer in the selection of television programs.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Modern information systems, such as televisions or the like, frequently offer a large number of programming choices. Examples of this problem include the large number of information and entertainment sources available via the internet, the radio, or the large number of channels available to users of a television system. Many systems offer so many choices that a user may be overwhelmed by the sheer number of available sources of content and, therefore, unable to effectively choose a content source of interest.

One example of a method used to help sift through online content has been referred to as “collective genius”, the “wisdom of crowds”, or “collective wisdom.” Collective wisdom is used in some online search engines for ranking search results. In a collective wisdom system, the more times that users visit a certain site, the higher ranked that site will be when listed in a search list generated by an online search engine. Thus, the more relevant a site is to people searching for specific content, the higher ranked it becomes in a search for that content because the “collective wisdom” of the users has ranked it as an important site for viewing the desired content.

Modern television programming consists of hundreds of channels with thousands of programs available for viewing. Unlike the internet though, there is limited guidance as to what shows would be worthwhile for a user to watch. With such a large availability of programming, coupled with limited guidance as to desirable content, users are potentially missing programming that they would find interesting or entertaining.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention;

FIG. 2 is a flow chart representing a method in accordance with one exemplary embodiment of the present invention; and

FIG. 3 is a diagram representing an on-screen display (OSD) in accordance with one exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

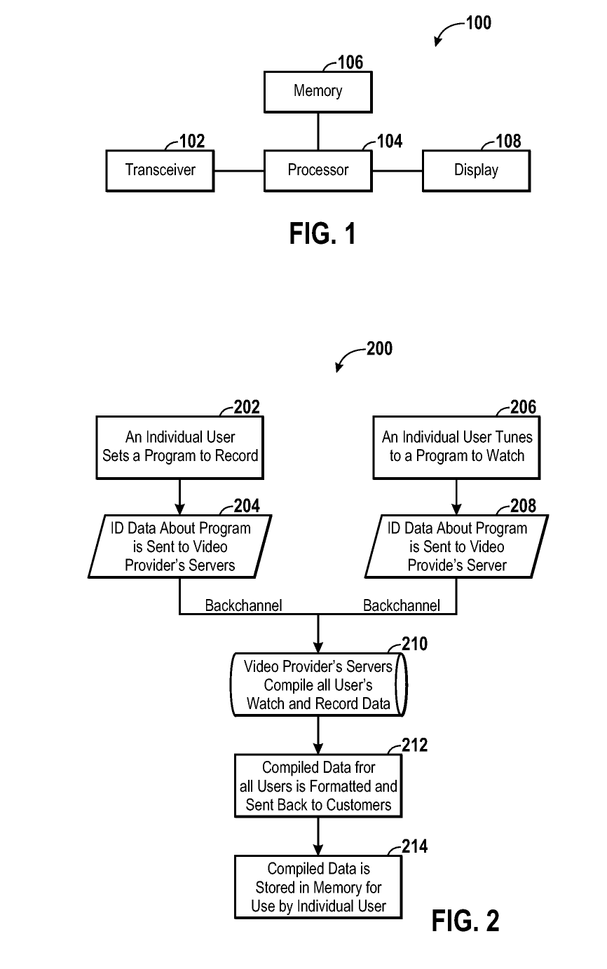

FIG. 1 is a block diagram of an electronic device 100 in accordance with an exemplary embodiment of the present invention. The electronic device 100 (for example, a television, a cable or satellite set top box or the like) comprises various subsystems represented as functional blocks in FIG. 1. In the exemplary embodiment shown in FIG. 1, the functional blocks include a transceiver 102, a processor 104, a memory 106 and a display 108. Those of ordinary skill in the art will appreciate that the various functional blocks shown in FIG. 1 may comprise hardware elements (including circuitry), software elements (including computer code stored on a machine-readable medium) or a combination of both hardware and software elements.

The transceiver 102 receives and transmits data, such as a broadcast spectrum containing a plurality of television programs. The data may be received from a variety of input sources such as a cable inlet, a satellite source, or a direct subscriber line (“DSL”). The transceiver 102 also transmits data via a backchannel. This backchannel can be the same as the input source channel. For example, 2-way CableCARD technology may be used as a backchannel. The backchannel may also be a secondary channel. For example, a phone modem, a Universal Serial Bus (“USB”) connection, or an Ethernet connection may be deployed as a secondary channel separate from the input source channel. One exemplary embodiment uses a wireless communication link as a secondary channel for transmission of data to an external device.

The processor 104, which controls the overall operation of the electronic device 100, is coupled to the transceiver 102. As one of its functions, the processor 104 controls the reception of information from an external source, such as collective wisdom information relating to current and upcoming programming. The processor 104 also controls the transmission of data via the transceiver 102 to external devices. Data transmitted from the electronic device may include data identifying programming the user of the electronic device 100 is currently listening to or watching, or that the user intends to listen to or watch in the future. The data sent by the electronic device 100 may be compiled into collective wisdom data that is transmitted to all users of a given entertainment service. The processor 104 may control a tuner (not shown) to tune a particular channel, which may be displayed on the display 108.

The processor 104 is adapted to access and store data in the memory 106. The memory 106 comprises a tangible, machine-readable medium that may be adapted to hold machine-readable computer code that causes the processor 104 to operate in accordance with an exemplary embodiment of the present invention. For example, the memory 106 may store computer code that causes the processor 104 to transfer data to the transceiver 102 for transmission to an external receiver. As set forth below, in one exemplary embodiment of the present invention, the processor 104 executes computer readable code that employs collective wisdom data to suggest content options to a user.

FIG. 2 is a block diagram representing a process in accordance with one exemplary embodiment of the present invention. The process is generally indicated by reference numeral 200. Moreover, the process 200 is an exemplary embodiment of the use of collective wisdom to offer programming suggestions to users of an entertainment system, such as a cable or satellite network, or the like. Such a process may be performed by the electronic device 100 (FIG. 1).

At block 202, the process begins when a user sets a device to automatically record a program. In one embodiment, a digital video recorder (DVR) is used to record the selected programming. At block 204, after the user has selected a program to record, information about the selected program is transmitted to a central processing facility of the content provider (a cable or satellite provider, for example). In one exemplary embodiment, transmission of information regarding the selected program to be recorded is transmitted to the content provider at periodically spaced intervals. For example, the information can be transmitted every thirty seconds.

The processor 104 (FIG. 1) may convey information about the selected program to the transceiver 102 (FIG. 1) for transmission to the content provider along a backchannel. The information transmitted to the content provider may be, for example, identification data associated with the program selected for recording.

In addition to providing information about programs that the user selects for recording, the electronic device 100 (FIG. 1) may also transmit information about programs that are being watched by the user (i.e., not recorded). For example, the user may tune to a particular program, as shown at block 206. Information about the selected program is then transmitted to the content provider, as shown at block 208. Information about the program being displayed may be transmitted to the content provider at periodic intervals (e.g., every 30 seconds), or whenever the user changes to a different program.

As shown at block 210, the content provider compiles information received from qualified network users into collective wisdom data, which may include ranking programs currently being watched by popularity or the like. Qualified users may include all users of a particular content delivery system. In an exemplary embodiment of the present invention, the collective wisdom data takes into account a viewing area in which viewers reside. In such an embodiment, the collective wisdom data provided to users may indicate which programs are popular in a viewer's particular viewing area. In alternative embodiments, collective wisdom data may be provided based on a user's, city, state, region or entire country. In an exemplary embodiment of the present invention, the user data about recorded programs and the user data about programs currently being watched may be compiled into collective wisdom data that includes both categories of data (watched and recorded).

At block 212, the compiled collective wisdom information is formatted for delivery back to individual users on the network. In one exemplary embodiment, the formatting process may include creating a list of currently viewed programs and a list of programs to be viewed in the future. The formatting may also create subcategories such as the most watched show now, the most watched show last hour, the most watched show last Sunday, the most watched show this year, etc. The formatting may similarly create subcategories such as the most recorded show last hour, the most recorded show last Sunday, the most recorded show this year, the most recorded show tomorrow, the most recorded show next week, etc.

The subcategories may include user rankings of specific shows, as well as specific channels. For example, users may rank programs currently being watched or set to be recorded, on a scale of 1-10 or 1-5 stars, etc. The subcategories may also include information offered to cross-link programs selected. For example, 80% of users who watch program A, also watch program B.

In another exemplary embodiment, the formatting of the compiled data includes compiling lists of a specified individual's current and future programming selections. In this embodiment, individual users are able to provide permission for others to view their program selections. For example, a first user may provide permission to a second user to receive compiled collective wisdom data about the first user's program selections. In this manner, the second user may view, for example, a list of programs that a friend (the first user) will be recording or is currently viewing.

Once the data has been formatted, the formatted compiled data is sent to the all qualified users in the predetermined area. The formatted compiled data will then be available for use by the individual users who constitute the qualified users in the predetermined area.

At block 214, the formatted compiled collective wisdom data is received and stored by a user device, such as the electronic device 100 (FIG. 1). In one embodiment, the transceiver 102 (FIG. 1) receives the formatted compiled collective wisdom data. This formatted compiled collective wisdom data is then conveyed to the processor 104. The processor 104 may store the formatted compiled data in memory 106 for use by an individual user.

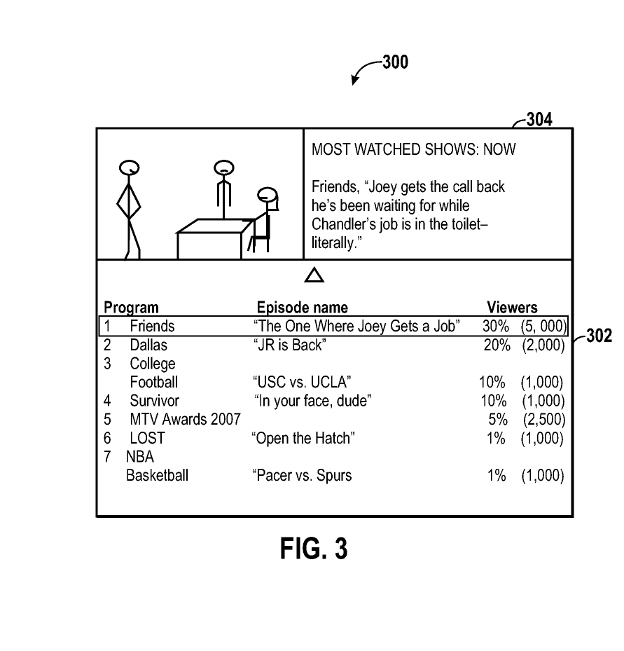

In one exemplary embodiment, the formatted compiled data is displayed to the user as an OSD. This OSD may list the most watched (popular) programs by program name, program description, the number of viewers or percentage of the total viewing audience that are watching the listed programs. The display may include other information, such as a graphic corresponding to a currently selected program. An example of such an OSD is shown in FIG. 3, and described in detail below. In one exemplary embodiment, the OSD may be an image that allows a user to interact with an interface device by means of a remote control.

In an exemplary embodiment of the present invention, the electronic device 100 (FIG. 1) is adapted to tune to the currently most popular program, as indicated by the latest collective wisdom data, when the electronic device 100 is turned on. In other words, a television operating in accordance with an exemplary embodiment of the present invention, may be adapted to tune the currently most watched program when turned on instead of tuning the most recently watched channel or a predetermined channel. Alternatively, the television may be adapted to tune to a most popular channel for the previous week, month or year when turned on. In yet another alternative embodiment, the television may be adapted to tune to a program currently being watched by a specified friend when the television is turned on.

In yet another exemplary embodiment, when a particular program is identified by the collective wisdom data as meeting or exceeding a user-specified popularity threshold, the television is automatically activated. For example, if a user sets a popularity threshold at 25%, then when 25% or more of the qualified users in the predetermined area are viewing or recording a specific program, the user's television would turn on and be tuned to the selected program without additional action by the user. Similarly, a recording device may be set to record any program that meets or exceeds the specified popularity threshold without additional action by the user.

FIG. 3 is a diagram representing an OSD in accordance with one exemplary embodiment of the present invention. The OSD is generally represented by the reference number 300. The exemplary OSD 300 shown in FIG. 3 comprises a listing 302 of currently available programming, along with data indicating the popularity of each individual program. The OSD 300 further comprises a description 304 of a program that may be highlighted in the listing 302.

In an exemplary embodiment of the present invention, when a program is identified in the collective wisdom data as meeting or exceeding a user-specified popularity threshold, an OSD indicating that a program meeting the user's popularity threshold may be displayed. For example, if a user set a threshold at 25%, then when 25% or more of the qualified users in the predetermined area are viewing or recording a specific program, the user's television would display an OSD, thus alerting the user of popular programming currently airing. The OSD may allow for interaction between the user and an interface device. For example, a user, upon seeing the OSD, might be given an option to have the popular show automatically tuned or recorded.

While the present techniques may be susceptible to various modifications and alternative forms, specific embodiments have been shown by way of example in the drawings and are described in detail herein. However, it should be understood that the techniques are not intended to be limited to the particular forms disclosed. For example, with regard to the processes discussed above, the user queries may be optional and may be asked or omitted depending on design. Further, certain aspects of the disclosed processes may be performed in an order different than that illustrated. It should be noted that the disclosed techniques are to cover all modifications, equivalents and alternatives falling within the spirit and scope of the techniques as defined by the following appended claims.

What is claimed is:

1. A method of identifying content of interest to a user, comprising:
transmitting information about a user selected program to a central processing facility;
receiving compiled collective wisdom data comprising information about a plurality of user-selected programs from the central processing facility; and
displaying the compiled collective wisdom data to an individual member of a user community to assist the individual member of the user community in selecting content of interest.

2. The method of claim 1, wherein the compiled collective wisdom data comprises data representing currently aired content.

3. The method of claim 1, wherein the compiled collective wisdom data comprises data representing content to be aired at some later time.

4. The method of claim 1, further comprising providing second compiled collective wisdom data about selected programs from a specified user to an individual member of a user community to assist the individual member of the user community in selecting content of interest.

5. The method of claim 4, wherein the second compiled collective wisdom data comprises data representing currently aired content.

6. The method of claim 1, wherein the second compiled collective wisdom data comprises data representing content to be aired at some later time.

7. The method of claim 1, wherein the compiled collective wisdom data is ranked according to the portion of the user community selecting each of the plurality of user selected programs to form ranked compiled collective wisdom data.

8. The method of claim 7, comprising displaying the ranked compiled collective wisdom data.

9. The method of claim 7, further comprising tuning an electronic device to a channel broadcasting a program ranked first in the ranked compiled collective wisdom data when the electronic device is activated.

10. The method of claim 7, further comprising activating an electronic device when a program exceeds a popularity threshold.

11. The method of claim 7, further comprising displaying a notice when a program exceeds a popularity threshold.

12. An electronic device, comprising:
a transceiver adapted to transmit information about a user-selected program to a central processing facility and to receive compiled collective wisdom data comprising a plurality of user-selected programs from the central processing facility;
a processor adapted to manage the compiled collective wisdom data; and
a display that, under control of the processor, provides a display of the compiled collective wisdom data to an individual member of a user community to assist the individual member of the user community in selecting content of interest to the individual member of the user community.

13. The electronic device of claim 12, wherein the compiled collective wisdom data comprises data representing currently aired content.

14. The electronic device of claim 12, wherein the compiled collective wisdom data comprises data representing content to be aired at some later time.

15. The electronic device of claim 12, further comprising providing second compiled collective wisdom data about selected programs from a specified user to an individual member of a user community to the transceiver to assist the individual member of the user community in selecting content of interest.

16. The electronic device of claim 12, wherein the compiled collective wisdom data is ranked according to the portion of the user community selecting each of the plurality of user-selected programs to form ranked compiled collective wisdom data.

17. The electronic device of claim 16, wherein the display is adapted to display the ranked compiled collective wisdom data.

18. The electronic device of claim 17, further comprising tuning the electronic device to a channel broadcasting a program ranked first in the ranked compiled collective wisdom data when the electronic device is activated.

19. The electronic device of claim 17, further comprising displaying a notice on the display when a program exceeds a popularity threshold.

20. An electronic system, comprising:
means for transmitting information about a user selected program to a central processing facility;
means for receiving compiled collective wisdom data comprising a plurality of user selected programs from the central processing facility; and
means for providing the compiled collective wisdom data to an individual member of a user community to assist the individual member of the user community in selecting content of interest to the individual member.
